(19) United States
(12) Patent Application Publication
(10) Pub. No.: US 2011/0169460 A1
(43) Pub. Date: Jul. 14, 2011

(54) HYBRID VEHICLES

(75) Inventor: Michael POTTER, Condove (IT)

(73) Assignee: GM GLOBAL TECHNOLOGY OPERATIONS LLC, Detroit, MI (US)

(21) Appl. No.: 12/968,111

(22) Filed: Dec. 14, 2010

(30) Foreign Application Priority Data
Dec. 14, 2009 (GB) 0921771.2

(51) Int. Cl. H02J 7/04

(52) U.S. Cl. 320/162; 180/65.21

(57) ABSTRACT

In a battery charging system for a hybrid vehicle, a user-operated switch is provided for triggering an engine to charge battery at an earlier stage for an extended journey as compared to a normal journey. A sensor is provided to detect a charge state level of the battery, the output of the sensor being compared at with a threshold set by switch.

### CROSS-REFERENCE TO RELATED APPLICATION

This application claims priority to British Patent Application No. 0921771.2, filed Dec. 14, 2009, which is incorporated herein by reference in its entirety.

### TECHNICAL FIELD

The technical field relates to hybrid vehicles and in particular to battery charging systems for hybrid vehicles.

### BACKGROUND

Plug-in hybrid and range extended electric vehicles have the potential to provide owners with substantial fuel cost savings and can ultimately reduce the dependence on petroleum fuels. With these vehicles, particularly range extended electric vehicles, the performance available is related to the availability of electric charge in the batteries to provide motive power or supplement the conventional internal combustion engine. Once the electric charge is depleted, the vehicle performance can be diminished.

In existing hybrid vehicles, an internal combustion engine is automatically triggered to charge a battery when its charge level falls below a fixed threshold. A disadvantage of this arrangement is that the same threshold may not be appropriate for all eventualities.

In view of the foregoing, at least one aspect seeks to avoid or at least reduce the number of occasions on which the battery electric charge is depleted and the vehicle cannot perform properly. At least another aspect seeks to provide a hybrid vehicle battery charging system in which the charging of the battery can take into account an actual or expected operating condition. In addition, other aspects, desirable features and characteristics will become apparent from the subsequent summary and detailed description, and the appended claims, taken in conjunction with the accompanying drawings and this background.

### SUMMARY

According to a first embodiment, there is provided a method of operating a hybrid vehicle in which, during a normal journey, the engine of the vehicle is triggered to charge a battery of the vehicle when the value of a battery variable falls below a predetermined threshold value and, during an arduous or extended journey, the engine is triggered to charge the battery when the variable value falls below a higher threshold. Thus when the user anticipates heavy usage of the vehicle, including a higher than usual load on the battery, the threshold can be raised to reduce the risk of depleted battery charge. The vehicle preferably has a user-operated button or other switch element to set the raised threshold value. The variable that is compared with the threshold value is preferably the state of charge of the battery. The threshold value can be set before the journey. The user may have a button or the switch element to cause the engine to charge the battery at all times.

According to a second embodiment, there is provided a hybrid vehicle battery charging system comprising a battery, a battery variable sensor, and a comparator which is connected to the sensor output and which compares the current value of the battery variable with an adjustable threshold value, the system further comprising a battery charging device that is connected to the comparator output and which is arranged to charge the battery when the battery variable falls below the currently-set threshold value.

At least one advantage of the above system is that it enables a user to set the threshold at which the battery is charged by the engine on occasions on which the default setting is not expected to maintain adequate performance. The threshold may be settable to two or more discrete levels or alternatively it may be continuously settable between two limit values. Both these arrangements enable different thresholds to be set in dependence on the expected length or degree of severity of the journey.

Alternatively, the engine may be triggered to charge the battery at all times. This is the equivalent of setting the threshold value at or above the value corresponding to the battery's normal state of charge. This setting is selected for a journey which was expected to be extremely long or extremely arduous, e.g., involving many steep hills. Additionally, it is selected for extremely important journeys, e.g. for emergency trips, when reliably completing the journey outweighs all other considerations.

### BRIEF DESCRIPTION OF THE DRAWINGS

The present invention will hereinafter be described in conjunction with the following drawing figures, wherein like numerals denote like elements, and:

FIG. 1 is a diagram of a battery charging system for a hybrid vehicle in accordance with a first embodiment; and

FIG. 2 is a diagram of a battery charging system for a range extended vehicle in accordance with a second embodiment.

### DETAILED DESCRIPTION

The following detailed description is merely exemplary in nature and is not intended to limit application and uses. Furthermore, there is no intention to be bound by any theory presented in the preceding background or summary or the following detailed description.

The expression “hybrid vehicle” as used in this specification covers all hybrid electric vehicles plug-in hybrids (PHEV), range-extended vehicles (REV) etc. In particular it embraces all vehicles having an internal combustion engine (or other secondary source of power), whether or not it is capable of directly driving road wheels or other propulsion members of the vehicle, and one or more batteries which are capable of providing power to an electric motor to drive the road wheels or other propulsion members. The vehicle may have any desired number of road wheels. The vehicle may be a motor cycle so that references to driving road wheels incorporate the singular in addition to the plural. Systems according to the embodiments can be employed in other types of vehicle including off-road vehicles or in trains.

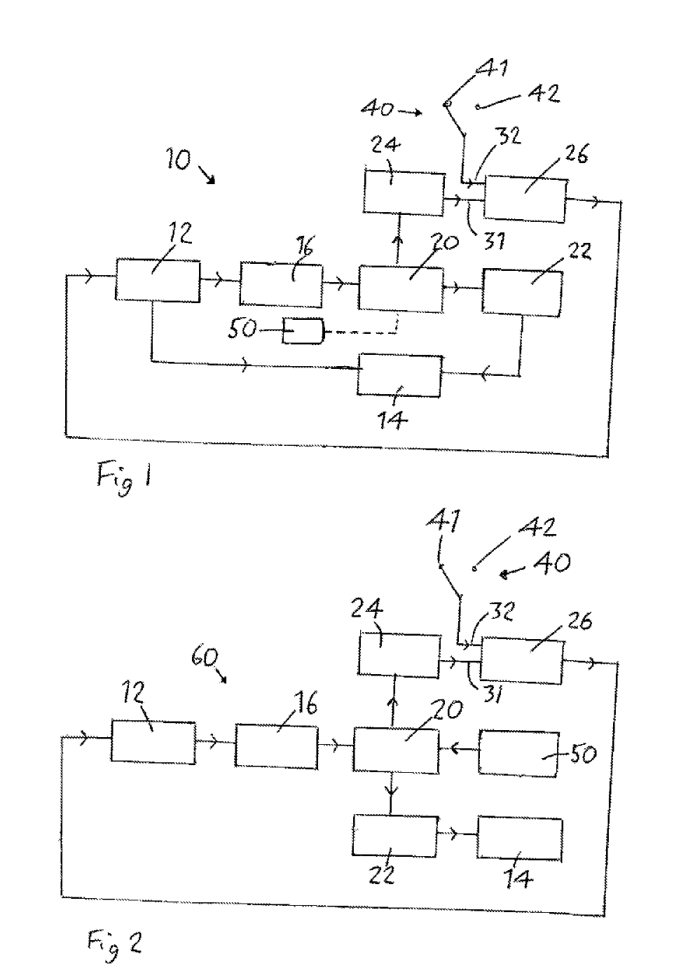

Referring to the drawings, FIG. 1 shows a battery charging system 10 of a hybrid vehicle, typically a car or other road vehicle. The system comprises an internal combustion engine 12 that is capable of providing mechanical output power directly to the drive train 14 to the driving road wheels of the vehicle. The engine 12 is also capable of supplying mechanical output power to a generator 16 which supplies electricity to a drive battery 20. When required, battery 20 provides electrical power to an electric motor 22, which in turn provides mechanical output power to the drive train 14 for the driving road wheels of the vehicle. When the vehicle is parked, the battery can be charged by being connected to the mains as indicated at 50.

The charge state of battery 20 is sensed by a charge level sensor 24, which supplies a corresponding output signal via line 31 to a first input of a comparator 26. A switch 40 is also provided, the output of which is supplied on line 32 to a second input of comparator 26. Switch 40 is manually actuated by a driver or other user of the vehicle. For example, it may be operated by a button on the dashboard. The input of switch 40 is selectively connected to a respective voltage level at one of two input terminals 41, 42. The voltages at terminals 41, 42 set respective threshold levels with which the signal on line 31 is compared.

When the signal on line 31 falls below the particular threshold set on line 32, the internal combustion engine 12 is triggered to provide power to generator 16 to charge battery 20. Charging of the battery continues until the threshold on line 32 is exceeded. If, at the time the signal on line 31 falls below the threshold, the engine 12 is not already operating, then it is switched on to provide the required power. If, however, the engine is already driving the road wheels, an appropriate fraction of its output is provided to generator 16. This may involve an increase in the mechanical output of the engine so that it continues to supply power to the drive train 14 at the same level in addition to supplying generator 16. Alternatively, some of the power supplied to drive train 14 may be diverted to generator 16, so that the power supplied to the drive train falls.

The voltage supplied to terminal 41 corresponds to a threshold suitable for normal operation of the vehicle, i.e., for journeys which are of normal length (e.g., journeys of a normal duration, at the end of which the battery can be recharged from the mains 50). The voltage supplied to terminal 42 corresponds to a higher threshold. This is suitable for extended journeys or journeys which are expected to be particularly arduous. The higher threshold signals to the comparator 26 that the engine should begin to charge the battery earlier than would normally occur. A user of the vehicle typically operates switch 40 to select the threshold before or at the start of a journey, but the selection can be made, or reversed, at any time.

An advantage of the above-described is that the electric charge of the battery does not become depleted and the vehicle performance remains satisfactory. Since this feature would only be used occasionally, the driver would experience the benefits of electric drive during normal commuting journeys, for example, but would have greater vehicle utility on the occasions at when it was expected to exceed the normal battery range.

In a preferred embodiment the sensor 24 detects the battery voltage to monitor the state of charge. Alternatively, chemical, current integration or pressure methods may be used to determine the state of charge of the battery. In a modification, the sensor 24 is implemented by any convenient sensing means, which may incorporate one or more sensors already provided in the system for other purposes.

Various modifications can be made to the above-described. For example the switch 40 may have more than two input terminals so that the threshold can be set to a corresponding number of values. Thus three settings can be provided corresponding to normal, extended and very extended journeys. The switch can be implemented as a push button or other input device, actuation of which produces a temporary current or voltage pulse to set a respective bit in a controller device. Instead of having a number of discrete values, the threshold input device may comprise a potentiometer or other device for providing a continuous or analog value on line 32. This permits a finer resolution for the threshold setting.

An additional override switching element may be provided, also operated by a user of the vehicle, which causes the engine permanently to charge the battery, i.e. to supply mechanical output to the generator to charge the battery throughout the entire journey. This effectively sets the threshold as being equal to or more than the normal charge state level of the battery.

The generator 16 may be used to drive the electric motor 22 directly. The arrangement may be used with all types of hybrid vehicle. For example, the vehicle may not have a plug-in facility, so that there is no option provided for connecting the battery to the mains, or other external power supply.

A battery charging system 60 for a range extended vehicle in accordance with a second embodiment of the present invention is shown in FIG. 2. Elements in common with the embodiment of FIG. 1 have the same reference numerals.

In this embodiment, only electric motor 22 is capable of directly driving the road wheels. In normal use of the vehicle, the principal power supply for battery 20 is from an external power supply such as the mains 50 when the vehicle is stationary. On some journeys, engine 12 may only be used in exceptional circumstances and may not be used at all. For extended journeys, the system in accordance with the present invention switches on the engine 12 at a much earlier stage than would be considered during normal journeys. The same modifications may be made to the second embodiment as to the first embodiment.

To enable the battery to be charged before a journey, either of the above described embodiments may comprise an additional user-operated switch to enable the engine to operate the generator to charge the battery while the vehicle is parked. Such a system is disclosed in our co-pending application entitled Battery Charging System for Hybrid Vehicles filed on even date. This co-pending application also discloses a method of charging a battery of a hybrid vehicle using an engine thereof, wherein, when the vehicle is being driven, a battery charge state level is sensed and, when it falls below a predetermined threshold, the engine is triggered automatically to charge the battery and, when the vehicle is parked, manually activating a switch element to operate the engine to charge the battery. The content of this co-pending application is hereby incorporated by reference. Although reference has been made to a battery 20, it will be appreciated that this is normally constituted by a bank of batteries.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method of operating a hybrid vehicle having an engine and a battery, comprising:
triggering the engine to charge the battery when a value of a battery variable falls below a predetermined threshold value during a normal journey; and
triggering the engine to charge the battery when the battery variable value falls below a higher threshold during a non-normal journey.

2. The method according to claim 1, wherein the non-normal journey is an arduous journey.

3. The method according to claim 1, wherein the non-normal journey is an extended journey.

4. A method according to claim 1, wherein the hybrid vehicle comprises a battery controller comprising a user-operated input control element adapted to receive the predetermined threshold value.

5. A method according to claim 1, wherein the predetermined threshold value is set before the normal journey.

6. A method according to claim 1, wherein the predetermined threshold value is set at least two discrete levels.

7. A method according to claim 1, wherein the predetermined threshold value is adjustable between two limit values.

8. A method according to claim 1, wherein the battery variable value is a state of charge of the battery.

9. A method according to claim 1, wherein the engine is controlled to charge the battery substantially throughout operation of the engine.

10. A battery charging system for a hybrid vehicle, comprising:
a battery;
a battery variable sensor;
a comparator connected to the battery variable sensor and adapted to compare a current value of a battery variable with an adjustable threshold value; and
a battery charging device connected to the comparator and adapted to charge the battery when the battery variable falls below a currently-set threshold value.

11. The system according to claim 10, wherein the battery charging device is a generator driven by an internal combustion engine of the hybrid vehicle.

12. The system according to claim 10, wherein the battery variable is a state of charge of the battery.

13. The system according to claim 10, wherein the adjustable threshold value is set by a user-operated control element.

14. The system according to claim 10, wherein the adjustable threshold value is settable to at least two discrete levels.

15. The system according to claim 11, further comprising a separate user-operated control element adapted to cause the battery charging device to charge the battery at substantially all times of operation of the hybrid vehicle.
